(19) United States
(12) Patent Application Publication
(10) Pub. No.: US 2022/0234179 A1
(43) Pub. Date: Jul. 28, 2022

(54) METALLIC STUD REMOVER AND A METHOD THEREFOR

(71) Applicant: Edward John Plesko, Ashley, MI (US)

(72) Inventor: Edward John Plesko, Ashley, MI (US)

(21) Appl. No.: 17/157,119

(22) Filed: Jan. 25, 2021

(51) Int. Cl. B25B 27/18; B25B 23/10; B25B 13/06

(52) U.S. Cl. CPC B25B 27/18; B25B 13/065; B25B 23/103

(57) ABSTRACT

In one embodiment, a handheld stud remover and in a second embodiment, a modified hex nut metal stud remover. In addition, there is a method of removing metal studs or bolts from threaded openings using the handheld stud remover and a method of removing metal studs or bolts from threaded openings using a modified hex nut metal stud remover.

### BACKGROUND OF THE INVENTION

One of the most frustrating activities in mechanical work is the removal of broken studs or bolts from metal products. Studs, threaded bolts or pins are commonly used in industrial applications to fasten equipment together or to fasten objects to some type of foundation.

Over time, these studs can become frozen through the process of varying temperatures or exposure to elements. Threaded bolts can become frozen and have their heads twisted off in the removal process, leaving the user with a stud still frozen in place. Broken bolts or studs generally have no means available to remove them after they have been broken. Thus, hex heads, slotted heads, and the like, disappear and there is now no means by which the studs can be removed.

Sometimes, studs or bolts can be removed by clamping onto the remainder of the stud by using pliers or vise grips and this is only if the stud breaks above the surface of the metal product being worked on. Typically, such breakage occurs within the threaded hole in which the bolt or stud is used. Thus, there is no way of clamping such a broken stud.

In the past, and indeed, in the prior art described infra, many stud removal tools are complex, either requiring many individual pieces, or are of a design which requires a considerable amount of effort and physical manipulation in removing the headless bolt from the associated mechanical device. In addition, such devices are expensive.

Devices of the prior art consist of a stud removal device disclosed in U.S. Design Patent 897,794 that issued Oct. 6, 2020 to Les Enterprises EZ Stud Out Inc, which discloses a nearly flat device having an opening in one end. The top surface of the opening is countersunk, and the bottom has a hex configured wrench head attached thereto that is centered over the opening.

U.S. Pat. No. 3,950,111 that issued Apr. 13, 1976 to Churchwell, et al deals with a cutting tool that can be used to remove studs.

U.S. Pat. No. 4,603,605 that issued Aug. 5, 1986 to Miller deals with a unitary, one-piece device for gripping threaded objects without damage to the threads. This device is useful for studs that have some amount of stud appearing above the metal in which it is used.

A tapered stud remover is disclosed in U.S. Pat. No. 4,651,596 that issued on Mar. 24, 1987 to Rachanski which can be rotated within the opening containing a broken stud wherein the taper member engages the internal taper of the sleeve member forcing finger splits on the pilot member to grip and frictionally lock on the free end of a stud.

U.S. Pat. No. 5,031,487 that issued on Jul. 16, 1991 to Polonsky deals with a broken bolt extractor comprising a right-hand threaded shaft having a left hand drill bit at its lower end.

A stud remover can be found in U.S. Pat. No. 5,907,983 that issued Jun. 1, 1999 to Spirer, that consists of a hex nut having slotted openings and through bolts to compress such openings together once the nut is aligned and contains an end of the stud.

Design patent 410,825 that issued Jun. 8, 1999 to Spirer deals with the same stud remover as in U.S. Pat. No. 5,907,983.

U.S. Pat. No. 6,073,520, that issued Jun. 13, 2000 to Bueno et al deals with a wrench for removing stud bolts. It relies on gripping toothed dog members to remove damaged studs.

Finally, U.S. Pat. No. 9,616,554, that issued Apr. 11, 2017 to Hendrix deals with a stud removal device that incorporates a body configured to hold a cage, cam sleeve and jaws for clamping on a broken stud.

None of the devices of the prior art have the simplicity or low cost of the devices of the instant invention.

### THE INVENTION

Thus, what is disclosed and claimed herein in one embodiment is a handheld stud remover. The stud remover comprises an essentially flat elongated metal strip having two rounded ends and a bottom surface. At least one end of the elongated metal strip has an opening through it and the through opening has a flare extending downwardly from the bottom surface of the elongated metal strip.

In a second embodiment, there is a modified hex nut metal stud remover. The modified hex nut has a centered opening and a bottom edge, wherein the bottom edge has a metal flared extension.

In yet another embodiment, there is a method of removing metal studs or bolts from threaded openings, the method comprising providing a flat metal strip handheld stud remover and placing a through opening in the elongated metal strip on top of a metal stud with the flared extension on the metal stud.

Then, welding the elongated metal strip through the opening, to the metal stud, and turning the elongated metal strip counterclockwise to remove the metal stud.

Still another embodiment is a method of removing metal studs or bolts from threaded openings. The method comprises providing a modified hex nut metal stud remover having a centered through opening and placing the centered opening on top of a metal stud with the metal flared extension on the metal stud and then welding the modified hex nut through the opening at the bottom edge to the metal stud. Thereafter, turning the modified hex nut counterclockwise to remove the metal stud.

It is contemplated within the scope of this invention to have rounded ends on the flat base to accommodate turning attached stud.

### BRIEF DESCRIPTION OF THE DRAWINGS

FIG. 1 is a full top view of a handheld device of this invention.

FIG. 2 is a full side view of a handheld device of this invention.

FIG. 3 is a side view of a separate embodiment of a device of this invention.

FIG. 4 is a full side view of a modified hex nut device of this invention.

FIG. 5 is a full top view of the device of FIG. 4.

FIG. 6 is a full bottom view of the device of FIG. 4.

FIG. 7 is a full top view of a device of this invention with different sized openings in it for multiple use.

FIG. 8 is an illustration of stud removal using a flat metal device 1 of this invention.

FIG. 9 is an illustration of stud removal using the modified hex nut device.

### DETAILED DESCRIPTION OF THE INVENTION

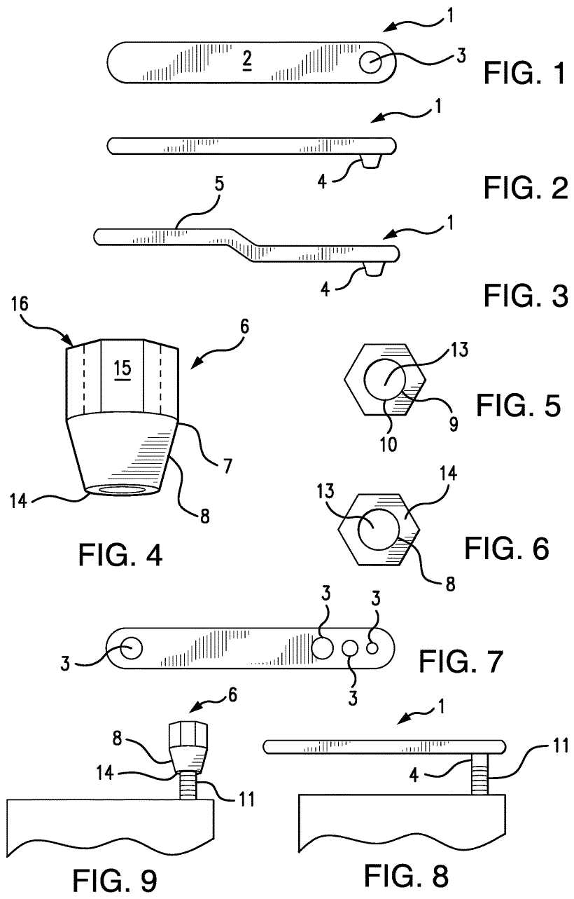

The devices of this invention are manufactured from metal, for example, iron and steel. FIG. 1 shows a full top view of a device 1 of this invention showing a flat, elongated metal base 2 having rounded ends. Such base 2 can be, for example, from 2 inches to 8 inches in length and the width is not critical but can be from about ¼ inch wide to about ¾ inch wide. The length and width are predetermined based on the amount of area that the device 1 will have to work in. The thickness of the metal base will vary based on the needed strength to turn the stud once the device 1 is welded to the broken stud. Generally, the thickness can be from about 1/32 inch to about ¼ inch thick.

The opening 3 is a through opening and there can be multiple openings of the same size or in various sizes in each metal base 2 depending on the need of the user.

FIG. 2 is a full side view of the device 1 showing the metal base 2 and a flared projection 4. The flared projection 4 is formed by essentially punching the opening 3. In this manner, the flair 4 is formed and it is formed as a very thin element. “Thin” for purposes of this invention means 1/16 inch or less in thickness.

It should be noted that by creating the opening 3, it can be done with a sharpened punch or an opening can be drilled and then punched with a punch slighter larger than the drilled opening 3 to push the metal through the opening to form the flare 4.

It should be noted that FIG. 3 shows a full side view of a device 1 of this invention in which the metal base 2 has been bent to provide a raised handle 5 to the device.

Turning now to another embodiment, please note FIG. 4 in which a modified hex nut 6 is shown. There is the hex nut 15, in general, having a centered opening 13. This centered opening 13 is larger in diameter than a normal hex nut opening to accommodate subsequent welding. The side wall 16 (FIG. 4) of the nut is thus thinner than it normally is. By creating the increased diameter of the opening, a remaining wall is created. Care must be taken to leave enough wall that will have strength to allow the turning of the stud after the welding is complete. The base 7 is narrowed or biased by grinding or the like, and then there is a hex nut flare 8 at the bottom 14. As like the device 1, this flare 8 is a very thin element. FIG. 5 shows the device 6 from the top 9, showing a threaded interior 10. FIG. 6 is the device 8 shown from the bottom 14 to illustrate the flare 8.

FIG. 7 is a device 1 of this invention showing multiple different sized holes in the same device. It is also contemplated within the scope of this invention to have openings 3 at both ends of the metal base 2.

Turning now to one method of removing metal studs or bolts from threaded openings as shown in FIG. 8, the method comprises providing a flat metal strip handheld stud remover 1 as set forth Supra and placing the through opening 3, in the elongated metal strip 2, on top of a metal stud 11 with the flared projection 4 on the metal stud 11.

Then, welding the elongated metal strip 2 through the opening 3 to the metal stud 11 and then turning the elongated metal strip 2 counterclockwise to remove the metal stud 11.

What is important at this juncture is that the flared projection 4 is very thin ( 1/16 inch or less in thickness), and when the weld is applied, it does not take very much welding to attach it to the stud 11. By this means, the metal substrate 12 is not overly heated or affected or harmed (See FIG. 8).

A second method shown in FIG. 9 comprises providing a modified hex nut metal stud remover 6 having a centered through opening 13 and placing the centered opening 13 on top of a metal stud 11, with the metal flared extension 8 on the metal stud 11, and then welding the modified hex nut 6 at the bottom edge 14 to the metal stud 11 through the opening 13. Thereafter, turning the modified hex nut stud remover 6 counterclockwise to remove the metal stud.

What is claimed is:

1. A handheld stud remover, said stud remover comprising an essentially flat elongated metal strip having two ends and a bottom surface;
at least one end of said two rounded ends of said elongated metal strip having an opening therethrough, said through opening having a flare extending downwardly from said bottom surface of said elongated metal strip.

2. A handheld stud remover as claimed in claim 1 wherein said elongated metal strip is cold rolled steel.

3. A handheld stud remover as claimed in claim 1 wherein said elongated metal strip has a length of from 2 inches to 8 inches.

4. A handheld stud remover as claimed in claim 1 wherein said elongated metal strip has a width of from ¼ inch to 1 inch.

5. A handheld stud remover as claimed in claim 1 wherein said elongated metal strip has a thickness of from 1/32 inch to ¼ inch.

6. A handheld stud remover as claimed in claim 1 wherein said flare has a length of from 1/32 inches to ¼ inches measured from said bottom surface of said elongated metal strip.

7. A handheld stud remover as claimed in claim 1 wherein said through opening has a diameter of from 3/16 inch to ¾ inch.

8. A modified hex nut metal stud remover, said modified hex nut having a centered opening and a bottom edge, said bottom edge being a metal flared extension.

9. A modified hex nut metal stud remover as claimed in claim 8 wherein said modified hex nut metal stud remover has a wrench size of from ¼ inch to 1 inch.

10. A modified hex nut metal stud remover as claimed in claim 8 wherein said modified hex nut metal stud remover bottom edge flared extension has a length of from 1/32 inches to ¼ inches.

11. A method of removing metal studs or bolts from threaded openings, said method comprising:
A. providing a handheld stud remover as claimed in claim 1;
B. placing said through opening in said elongated metal strip on top of said metal stud with said flared extension on said metal stud;
C. welding said elongated metal strip at said opening to said metal stud;
D. turning said elongated metal strip counterclockwise to remove said metal stud.

12. A method of removing metal studs or bolts from threaded openings, said method comprising:
i. providing a modified hex nut metal stud remover as claimed in claim 8;
ii. placing said centered opening on top of said metal stud with said metal flared extension on said metal stud;
iii. welding said modified hex nut at said opening at said bottom edge to said metal stud;
iv. turning said modified hex nut counterclockwise to remove said metal stud.

13. A handheld stud remover as claimed in claim 1 wherein the flat elongated metal strip has square ends.

14. A handheld stud remover as claimed in claim 1 wherein the flat elongated metal strip has rounded ends.
